(19) United States
(12) Patent Application Publication
(10) Pub. No.: US 2013/0109823 A1
(43) Pub. Date: May 2, 2013

(54) POLYMERS HAVING CHELATING FUNCTIONALITY

(71) Applicant: Rohm and Haas Company, Philadelphia, PA (US)

(72) Inventors: Scott Backer, Philadelphia, PA (US); Allen S. Bulick, Lansdale, PA (US); Joseph Manna, Quakertown, PA (US)

(73) Assignee: ROHM AND HAAS COMPANY, Philadelphia, PA (US)

(21) Appl. No.: 13/665,125

(22) Filed: Oct. 31, 2012

Related U.S. Application Data
(60) Provisional application No. 61/553,658, filed on Oct. 31, 2011.
(60) Provisional application No. 61/553,615, filed on Oct. 31, 2011.

(51) Int. Cl. C08F 22/02; C08F 22/38; C08F 28/02; C08F 24/00

(52) U.S. Cl. 526/273; 526/312; 526/307.3; 526/287

(57) ABSTRACT

The present invention provides novel polymers having chelating functionality and comprising units derived from an ethylenically unsaturated aminocarboxylate monmomer which comprises units derived from ethylenediamino disuccinic acid or its salt and a polymerizable ethylenically unsaturated monomer. The polymerizable ethylenically unsaturated monomer may be selected from divinylbenzene monoepoxide, allylglicidyl ether, and glycidyl(meth)acrylate. The polymer may also comprise units derived from one or more ethylenically unsaturated monomers.

### FIELD OF THE INVENTION

The present invention relates to novel polymers having chelating functionality and comprising units derived from an ethylenically unsaturated aminocarboxylate monomer. The ethylenically unsaturated aminocarboxylate monomer comprised units derived from ethylenediamine disuccinic acid or its salt and units derived from an ethylenically unsaturated monomer.

### BACKGROUND OF THE INVENTION

Synthetic detergents typically consist of a dispersant, a builder, and other miscellaneous ingredients such as brighteners, perfumes, anti-redeposition agents and enzymes. The dispersant typically comprises a surfactant and functions to separate dirt, soil and stains from fabric and other substrates. Polyacrylates are well known and commonly used dispersant compounds. The builder binds with and forms a complex with metal cations, such as calcium and magnesium ions found in “hard water,” which otherwise interfere with the dispersant activity. Such binding and complex formation is also commonly referred to as “chelating” and compounds capable of such interaction with metal ions are known as “chelating agents.”

Phosphates are excellent chelating agents, which is why they were historically used as builders for detergents. However, large amounts of phosphorus were released to streams, rivers, lakes and estuaries, even after wastewater treatment. In natural water bodies, phosphorous acts as a fertilizer, increasing growth of algae and aquatic weeds, which depletes oxygen available for healthy fish and aquatic life whose numbers then decreased. Consequently, most jurisdictions have limited or banned the use of phosphates in detergents.

In the search for phosphate substitutes, aminocarboxylate compounds have been found to be effective chelating agents and, therefore, useful as builders for laundry and automatic dishwashing detergents. For example, U.S. Pat. No. 3,331,773, teaches preparation of water soluble polymers having chelating functionality by grafting water soluble chelating monomers onto water soluble polymers. Diethylenetriamine, ethylenediamine tetraacetic acid, and other polyalkylene polyamine polyacetic acids are identified as examples of chelating monomers suitable for grafting onto water soluble polymers.

U.S. Pat. No. 5,514,732 also describes contact lenses made from water insoluble polymers having chelating functionality. The polymers are made from aminopolycarboxylic acids with a polymerizable olefinic group, as well as a hydrophilic monomer and one or more crosslinking monomer.

U.S Patent Application No. 2008/00262192 describes an water-soluble polymer having a high chelating performance and clay dispersancy which is made by polymerizing an amino group-containing allyl monomer derived from adding an amine compound, such as iminodiacetic acid (IDA), to an allyl monomer, such as allyl glycidyl ether (AGE). Also according to U.S Patent Application No. 2008/00262192, the amino group-containing allyl monomer may be polymerized with other polymerizable monomers including, without limitation, unsaturated monocarboxylic acid monomers.

U.S Patent Application No. 2009/0082242 discloses a phosphate free dish washing liquor comprising exfoliated nanoclay, a clay-dispersing polymer, as well as other components including known chelating agents such as nitrilotriacetates (NTA), ethylene diamine tetraacetate (EDTA), propylene diamine tetraacetic acid, (PDTA), ethylene diamine N,N′-disuccinic acid (EDDS) and methyl glycine diacetic acid (MGDA), or their salts.

The present invention provides novel polymerizable monomer compounds which have chelating functionality, as well as polymers made therefrom which shall be useful in aqueous systems for scale inhibition, soil removal, tea destaining, particulate dispersion and metal ion binding.

### SUMMARY OF THE INVENTION

The present invention provides a polymer having chelating functionality comprising units derived from (a) an ethylenically unsaturated aminocarboxylate monomer having the following general structure:

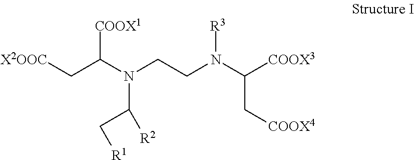

wherein X¹, X², X³ and X⁴ are each, independently, hydrogen or a mono- or polyvalent cation and the total charge on the monomer is zero; one of R¹ and R² is an —OH group, and the other is a polymerizable arm comprising an ethylenically unsaturated group;

and R³ is either:

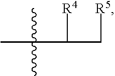

wherein one of R⁴ or R⁵ is an —OH group and the other is a polymerizable arm comprising an ethylenically unsaturated group and derived from one or more ethylenically unsaturated monomers, or

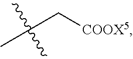

wherein X⁵ is hydrogen or a mono- or polyvalent cation.

In some embodiments, the polymerizable arm of Structure I may be derived from a (o-, p-, m-)DVBMO monomer and have the following structure:

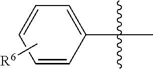

wherein R⁶ is a polymerizable ethylenically unsaturated group located at the ortho-, para-, or meta-substituted position of the benzene ring. The ethylenically unsaturated aminocarboxylate monomer according to claim 2, wherein R⁶ is —CH═CH₂.

In some embodiments, the polymerizable arm of Structure I may be derived from an allyl glycidyl ether monomer and have the following structure:

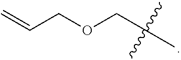 [SMILES: *COCC=C]

In some embodiments, the polymerizable arm of Structure I may be derived from a glycidyl(meth)acrylate monomer and have the following structure:

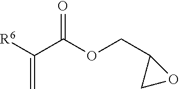

wherein R⁶ is hydrogen or —CH₃.

The polymer according to the present invention may further comprise units derived from (b) one or more ethylenically unsaturated monomers. In some embodiments, the one or more ethylenically unsaturated monomers are selected from the group consisting of carboxylic acids, esters of carboxylic acids, carboxylic acid anhydrides, imides, amides, styrenes, sulfonic acids, and combinations thereof.

The polymer according to the present invention may comprise (a) 0.5-99.5%, by weight, of the ethylenically unsaturated aminocarboxylate monomer, and (b) 99.5-0.5%, by weight, of the one or more ethylenically unsaturated monomers, based on the total weight of the polymer.

### DETAILED DESCRIPTION OF THE INVENTION

All percentages stated herein are weight percentages (wt %), unless otherwise indicated.

Temperatures are in degrees Celsius (° C.), and ambient temperature means between 20 and 25° C., unless specified otherwise.

Weight percentages of monomers are based on the total weight of monomers in the polymerization mixture.

The term “polymerized units derived from” as used herein refers to polymer molecules that are synthesized according to polymerization techniques wherein a product polymer contains “polymerized units derived from” the constituent monomers which are the starting materials for the polymerization reactions.

“Polymer” means a polymeric compound or “resin” prepared by polymerizing monomers, whether of the same or different types. The generic term “polymer,” as used herein, includes the terms “homopolymer” and “copolymer”. For example, homopolymers are polymeric compounds are understood to have been prepared from a single type of monomer. Copolymers, as this term is used herein, means polymeric compounds prepared from at least two different types of monomers. For example, an acrylic acid polymer comprising polymerized units derived only from acrylic acid monomer is a homopolymer, while a polymer comprising polymerized units derived from acrylic acid, methacrylic acid, and butyl acrylate is a copolymer. “Ethylenically unsaturated monomers” means molecules having one or more carbon-carbon double bonds, which renders them polymerizable. Monoethylenically unsaturated monomers have one carbon-carbon double bond, while multi-ethylenically unsaturated monomers have two or more carbon-carbon double bonds. As used herein, ethylenically unsaturated monomers include, without limitation, carboxylic acids, esters of carboxylic acids, carboxylic acid anhydrides, imides, amides, styrenes, sulfonic acids, and combinations thereof. Carboxylic acid monomers include, for example, acrylic acid, methacrylic acid, and salts and mixtures thereof. Sulfonic acid monomers include, for example, 2-(meth)acrylamido-2-methylpropanesulfonic acid, 4-styrenesulfonic acid, vinylsulfonic acid, 2-sulfoethyl(meth)acrylic acid, 2-sulfopropyl(meth)acrylic acid, 3-sulfopropyl(meth)acrylic acid, and 4-sulfobutyl(meth)acrylic acid and salts thereof. Further examples of ethylenically unsaturated monomers include, without limitation, itaconic acid, maleic acid, maleic anhydride, crotonic acid, vinyl acetic acid, acryloxypropionic acid, methyl acrylate, ethyl acrylate, butyl acrylate, methyl methacrylate, ethyl methacrylate, butyl methacrylate and isobutyl methacrylate; hydroxyalkyl esters of acrylic or methacrylic acids such as hydroxyethyl acrylate, hydroxypropyl acrylate, hydroxyethyl methacrylate, and hydroxypropyl methacrylate; acrylamide, methacrylamide, N-tertiary butyl acrylamide, N-methyl acrylamide, N,N-dimethyl acrylamide; acrylonitrile, methacryionitrile, allyl alcohol, allyl sulfonic acid, allyl phosphonic acid, vinylphosphonic acid, dimethylaminoethyl acrylate, dimethylaminoethyl methacrylate, phosphoethyl methacrylate, phosphonoethyl methacrylate (PEM), and sulfonoethyl methacrylate (SEM), N-vinyl pyrollidone, N-vinylformamide, N-vinylimidazole, ethylene glycol diacrylate, trimethylotpropane triacrylate, diallyl phthalate, vinyl acetate, styrene, divinyl benzene, allyl acrylate, 2-acrylamido-2-methyl propane sulfonic acid (AMPS) and its salts or combinations thereof.

As used herein “(meth)acrylic” are acrylic acid or methacrylic acid

As used herein “(meth)acrylates” are esters of acrylic acid or methacrylic acid.

The present invention relates to new monomer compositions which are polymerizable monomers having chelating functionality and are referred to hereinafter as “ethylenically unsaturated aminocarboxylate monomers.” The ethylenically unsaturated aminocarboxylate monomers of the present invention have the following general Structure I:

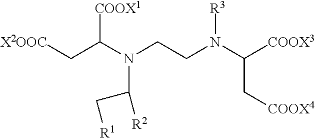

wherein X¹, X², X³ and X⁴ are each, independently, hydrogen or a mono- or polyvalent cation and the total charge on the monomer is zero; one and only one of R¹ and R² is an —OH group, and the other is a polymerizable arm comprising an ethylenically unsaturated group and having one of the following structures:

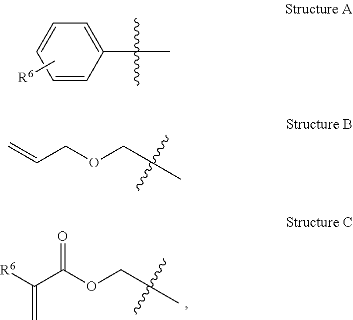

wherein R⁶ of Structure A is a polymerizable ethylenically unsaturated group located at the ortho-, para-, or meta-substituted position of the benzene ring. For example, R⁶ may be —CH═CH₂. Hereinafter, abbreviations for the possible structures of DVBMO in the ortho, para, and meta positions are o-DVBMO, p-DVBMO, and m-DVBMO. Note that “(o-, p-, m-)DVBMO” means one or more of the o-DVBMO, p-DVBMO, and m-DVBMO; and R³ is either:

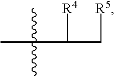

wherein one of R⁴ or R⁵ is an —OH group and the other is a polymerizable arm comprising an ethylenically unsaturated group and having one of the foregoing Structures A, B, or C, or

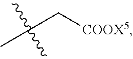

wherein X⁵ is hydrogen or a mono- or polyvalent cation.

In some embodiments, X¹, X², X³ and X⁴ of Structure I may each, independently, be at least one cation selected from the group consisting of: Na⁺, K⁺, NR₄⁺,organic ammonium ions, Ca²⁺ and Mg²⁺. Also, in some embodiments, X⁵ of the R3 group may be at least one cation selected from the group consisting of: Na⁺, K⁺, NH₄₊, organic ammonium ions, Ca²⁺ and Mg²⁺.

Each of Structures A, B and C are derived from one or more polymerizable ethylenically unsaturated monomers. Structure A may, for example, be derived from a divinylbenzene monoepoxide (DVBMO) monomer, such as ortho-divinylbenzene monoepoxide meta-divinylbenzene monoepoxide, para-divinylbenzene monoepoxide, or mixtures thereof. Divinylbenzene monoepoxide has the general structure shown below:

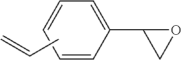

Structure B may, for example, be derived from an allylglicidyl ether (AGE) monomer of the following structure:

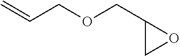

Structure C may, for example, be derived from a glycidyl(meth)acrylate (GA or GMA) monomer of the following structure:

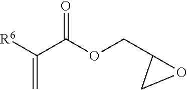

wherein R⁶ is hydrogen or —CH₃.

The present invention also provides a process for making the ethylenically unsaturated aminocarboxylate monomers which comprises reacting ethylenediamine disuccinic acid (EDDS), or its salt, with a polymerizable ethylenically unsaturated monomer selected from the group consisting of: divinylbenzene monoepoxide (DVBMO), allylglicidyl ether (AGE) and glycidyl(meth)acrylate. This reaction may occur in the presence of a phase transfer catalyst such as, without limitation, benzyltrimethylammonium chloride, tetra-n-butylammonium bromide, methyltrioctylammonium chloride, hexadecyltributylphosphonium bromide, dimethyldiphenylphosphonium iodide, and methyltriphenoxyphosphonium iodide. The EDDS and ethylenically unsaturated monomer may be reacted in any ratio. It is noted that providing an excess of the ethylenically unsaturated monomer may be beneficial as that should ensure 100% conversion of the EDDS. The process for making the ethylenically unsaturated aminocarboxylate in accordance with the present invention may be conducted at ambient temperatures.

The particular reaction scheme for the reaction of EDDS with GMA is as follows:

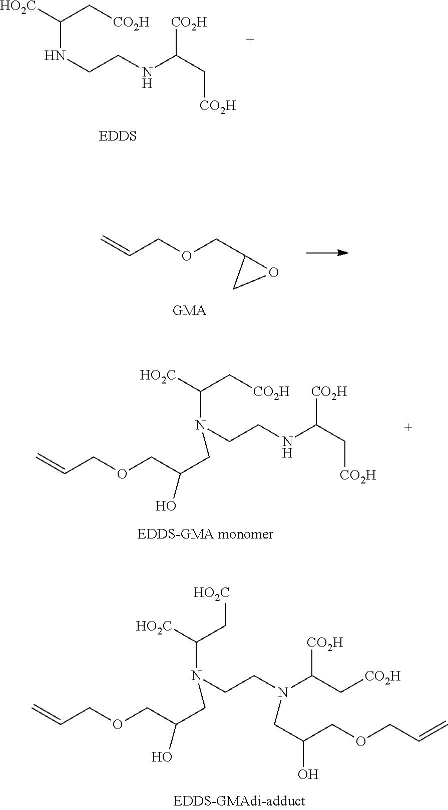

As will be recognized by persons of ordinary skill in the relevant art, a portion or all of the products shown above may be in the form of salts thereof, in which one or more of the pendant hydrogen atoms on each molecule may be substituted with a mono- or polyvalent cation. For the sake of simplicity in the following discussion, the structures will be shown having pendant hydrogen atoms with the understanding that one or more of them may be substituted with a cation as just described. The foregoing reaction produces a mixture of EDDS-GMA monomers, in accordance with the ethylenically unsaturated aminocarboxylates of the present invention, having the following structures:

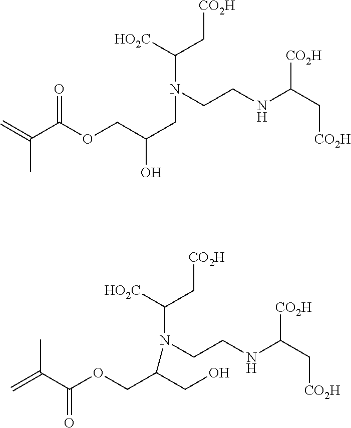 [SMILES: C=C(C)C(=O)OCC(O)CN(CCNC(CC(=O)O)C(=O)O)C(CC(=O)O)C(=O)O ; C=C(C)C(=O)OCC(CO)N(CCNC(CC(=O)O)C(=O)O)C(CC(=O)O)C(=O)O]

The foregoing reaction products EDDS-GMA may be subsequently reacted with chloroacetic acid or any chlorocarboxylate, or their salts, to generate ethylenically unsaturated aminocarboxylate monomers in accordance with the present invention which have the following structures:

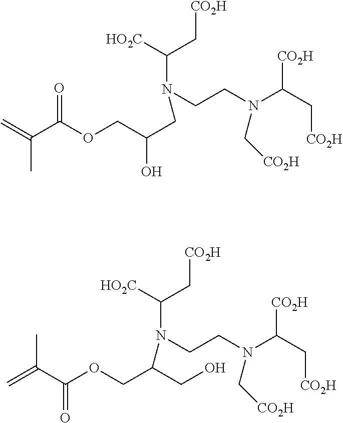 [SMILES: C=C(C)C(=O)OCC(O)CN(CCN(CC(=O)O)C(CC(=O)O)C(=O)O)C(CC(=O)O)C(=O)O ; C=C(C)C(=O)OCC(CO)N(CCN(CC(=O)O)C(CC(=O)O)C(=O)O)C(CC(=O)O)C(=O)O]

Additionally, as noted in the reaction scheme diagram above, the reaction process which generates EDDS-GMA also results in a certain percentage of di-adduct products with two ethylenically unsaturated components instead of one. A range of di-adduct in the reaction mixture of 25%-100% can be achieved and controlled by adjusting synthesis conditions. The structures of these di-adducts are shown below.

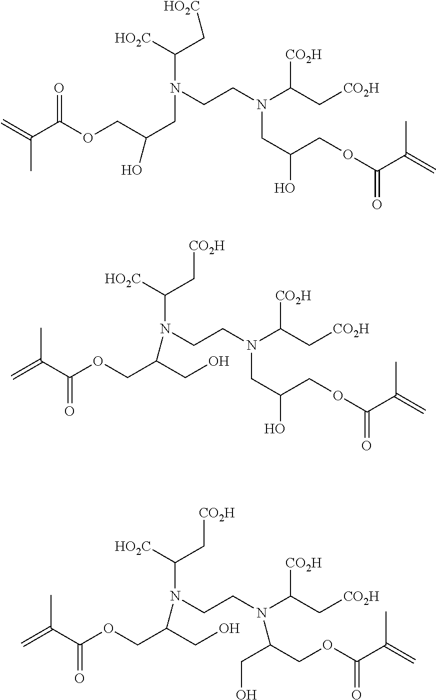

As will be readily recognized by persons of ordinary skill in the relevant art, other ethylenically unsaturated monomers, such as AGE or (o-, m-, p-)DVBMO, may be substituted for GMA in the above-described reactions to produce EDDS-AGE or EDDS-(o-, m-, p-)DVBMO monomers according to the present invention. In either case, obviously, persons of ordinary skill will expect that the product will contain the structures shown below, as well as their isomers.

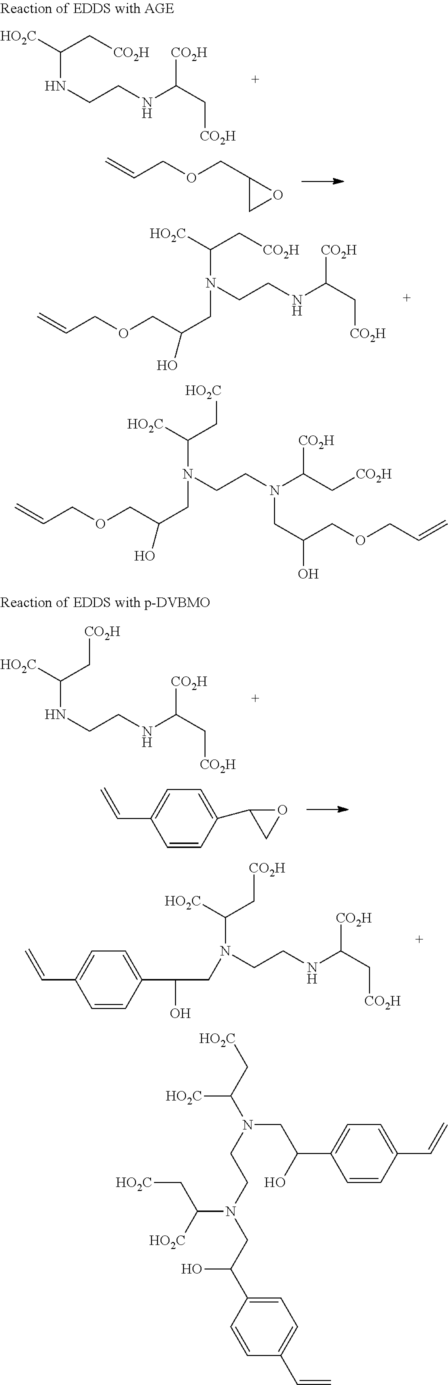

As a further example, the reaction between EDDS and a mixture of (o-, m-, p-)DVBMO produces a mixture of EDDS-DVBMO monomers, in accordance with the ethylenically unsaturated aminocarboxylates of the present invention, having the following structures:

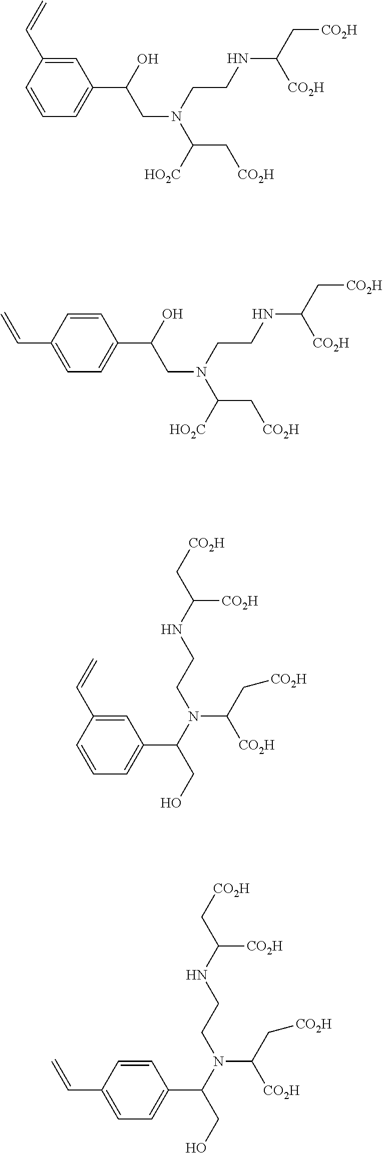 [SMILES: C=Cc1cccc(C(O)CN(CCNC(CC(=O)O)C(=O)O)C(CC(=O)O)C(=O)O)c1 ; C=Cc1ccc(C(O)CN(CCNC(CC(=O)O)C(=O)O)C(CC(=O)O)C(=O)O)cc1 ; C=Cc1cccc(C(CO)N(CCNC(CC(=O)O)C(=O)O)C(CC(=O)O)C(=O)O)c1 ; C=Cc1ccc(C(CO)N(CCNC(CC(=O)O)C(=O)O)C(CC(=O)O)C(=O)O)cc1]

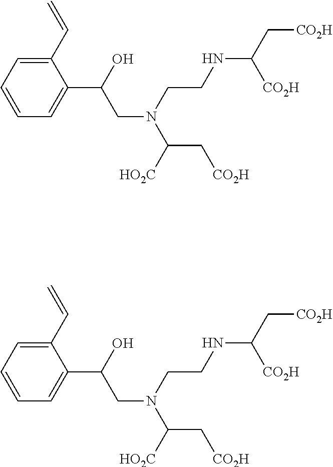 [SMILES: C=Cc1ccccc1C(O)CN(CCNC(CC(=O)O)C(=O)O)C(CC(=O)O)C(=O)O ; C=Cc1ccccc1C(O)CN(CCNC(CC(=O)O)C(=O)O)C(CC(=O)O)C(=O)O]

The foregoing reaction products EDDS-(o-, m-, p-)DVBMO may be subsequently reacted with chloroacetic acid or any chlorocarboxylate to generate ethylenically unsaturated aminocarboxylate monomers in accordance with the present invention which have the following structures:

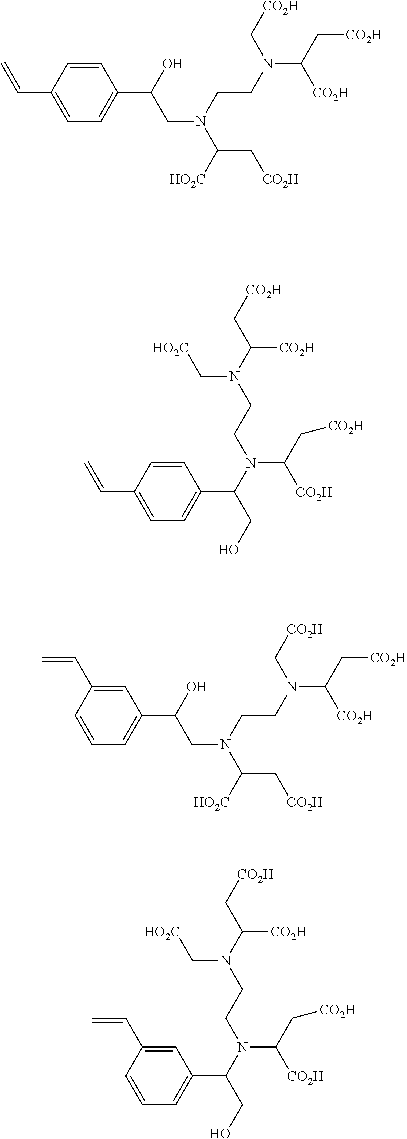 [SMILES: C=Cc1ccc(C(O)CN(CCN(CC(=O)O)C(CC(=O)O)C(=O)O)C(CC(=O)O)C(=O)O)cc1 ; C=Cc1ccc(C(CO)N(CCN(CC(=O)O)C(CC(=O)O)C(=O)O)C(CC(=O)O)C(=O)O)cc1 ; C=Cc1cccc(C(O)CN(CCN(CC(=O)O)C(CC(=O)O)C(=O)O)C(CC(=O)O)C(=O)O)c1 ; C=Cc1cccc(C(CO)N(CCN(CC(=O)O)C(CC(=O)O)C(=O)O)C(CC(=O)O)C(=O)O)c1]

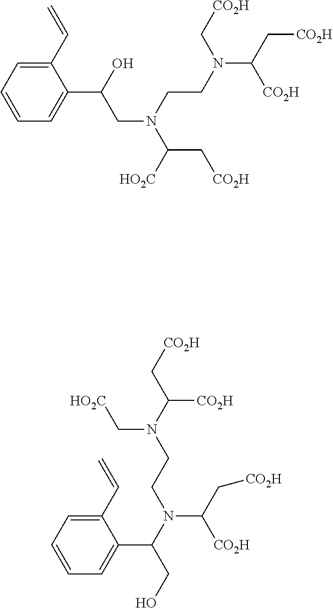 [SMILES: C=Cc1ccccc1C(O)CN(CCN(CC(=O)O)C(CC(=O)O)C(=O)O)C(CC(=O)O)C(=O)O ; C=Cc1ccccc1C(CO)N(CCN(CC(=O)O)C(CC(=O)O)C(=O)O)C(CC(=O)O)C(=O)O]

As with the EDDS-GMA reaction, the reaction between EDDS and (o-, m-, p-)DVBMO results in a certain percentage of di-adduct products with two ethylenically unsaturated components deriving from addition of EDDS to (o-, m-, p-)DVBMO.

The present invention also provides a polymer having chelating functionality which comprises units derived from the ethylenically unsaturated aminocarboxylate monomer and, optionally, one or more ethylenically unsaturated monomers.

For example, the one or more ethylenically unsaturated monomers may be selected from the group consisting of carboxylic acids, esters of carboxylic acids, maleics, styrenes, sulfonic acids, and combinations thereof.

In some embodiments, the polymer according to the present invention is a homopolymer comprising 100%, by weight, of the ethylenically unsaturated aminocarboxylate monomer.

In other embodiments, the polymer according to the present invention may comprise at least 0.5%, by weight, of the ethylenically unsaturated aminocarboxylate monomer, for example, at least 5% by weight, or at least 20% by weight, or at least 30% by weight, or even at least 40% or 50%, by weight, of the ethylenically unsaturated aminocarboxylate monomer, based on the total weight of the polymer. Furthermore, the polymer according to the present invention may comprise up to 99.5%, by weight, of the ethylenically unsaturated aminocarboxylate monomer, for example, up to 95% by weight, or up to 90% by weight, or up to 80% by weight, or even up to 75% or 60%, by weight of the ethylenically unsaturated aminocarboxylate monomer, based on the total weight of the polymer.

Furthermore, the polymer according to the present invention may comprise at least 0.5%, by weight, of the one or more ethylenically unsaturated monomers, for example, at least 5% by weight, or at least 20% by weight, or at least 30% by weight, or even at least 40% or 50%, by weight, of the one or more ethylenically unsaturated monomers, based on the total weight of the polymer. Furthermore, the polymer according to the present invention may comprise up to 99.5%, by weight, of the one or more ethylenically unsaturated monomers, for example, up to 95% by weight, or up to 90% by weight, or up to 80% by weight, or even up to 75% or 60%, by weight of the one or more ethylenically unsaturated monomers, based on the total weight of the polymer.

The method of polymerization is not particularly limited and may be any method known, now or in the future, to persons of ordinary skill including, but not limited to, emulsion, solution, addition and free-radical polymerization techniques.

For example, in some embodiments, the polymer having chelating functionality in accordance with the present invention may be produced using one or more free-radical polymerization reactions. Among such embodiments, some involve the use of one or more initiators. An initiator is a molecule or mixture of molecules that, under certain conditions, produces at least one free radical capable of initiating a free-radical polymerization reaction. Photoinitiators, thermal initiators, and “redox” initiators, among others, are suitable for use in connection with the present invention. Selection of particular initiators will depend on the particular monomers being polymerized with one another and is within the capability of persons of ordinary skill in the relevant art. Examples of photoinitiators include benzophenone, acetophenone, benzoin ether, benzyl dialkyl ketones, and derivatives thereof. Examples of suitable thermal initiators are inorganic peroxo compounds, such as peroxodisulfates (ammonium and sodium peroxodisulfate), peroxosulfates, percarbonates and hydrogen peroxide; organic peroxo compounds, such as diacetyl peroxide, di-tert-butyl peroxide, diamyl peroxide, dioctanoyl peroxide, didecanoyl peroxide, dilauroyl peroxide, dibenzoyl peroxide, bis(o-tolyl)peroxide, succinyl peroxide, tert-butyl peracetate, tert-butyl permaleate, tert-butyl perisobutyrate, tert-butylperpivalate, tert-butyl peroctoate, tert-butyl pemeodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate; azo compounds, such as 2,2′-azobisisobutyronitrile, 2,2′-azobis(2-methylbutyronitrile), 2,2′-azobis(2-methylpropionamidine)dihydrochloride, and azobis(2-amidopropane)dihydrochloride.

In some embodiments, thermal initiators can optionally be used in combination with reducing compounds. Examples of such reducing compounds are phosphorus-containing compounds, such as phosphorus acid, hypophosphites and phosphinates; sulfur-containing compounds, such as sodium hydrogen sulfite, sodium sulfite, sodium metabisulfite, and sodium formaldehyde sulfoxylate; and hydrazine. It is considered that these reducing compounds, in some cases, also function as chain regulators.

Another category of suitable initiators is the group of persulfates, including, for example, sodium persulfate. In some embodiments one or more persulfate is used in the presence of one or more reducing agents, including, for example, metal ions (such as, for example, ferrous ion), sulfur-containing ions (such as, for example, S2O3(=), HSO3(−), SO3(=), S2O5(=), and mixtures thereof), and mixtures thereof.

When initiator is used, the amount of all initiator used, as a weight percentage based on the total weight of all monomers used, is 0.01% or more; or 0.03% or more; or 0.1% or more; or 0.3% or more. Independently, when initiator is used, the ratio of the weight of all initiator used to the total weight of all monomers used is 10% or less, such as 5% or less; or 3% or less; or even 1% or less.

When initiator is used, it may be added in any fashion, at any time during the process. For example, some or all of the initiator may be added to the reaction vessel at the same time that one or more of the monomers is being added to the reaction vessel. In some embodiments, the initiator is added with a constant rate of addition. In other embodiments, the initiator is added with an increasing rate of addition, for example in two or more steps, where each step uses a higher rate of addition than the previous step. In some embodiments, the rate of addition of initiator increases and then decreases.

Production of the polymer having chelating functionality in accordance with the present invention may also involve the use of a chain regulator. A chain regulator is a compound that acts to limit the length of a growing polymer chain. Some suitable chain regulators are, for example, sulfur compounds, such as mercaptoethanol, 2-ethylhexyl thioglycolate, thioglycolic acid, and dodecyl mercaptan. Other suitable chain regulators are the reducing compounds mentioned herein above. In some embodiments, the chain regulator includes sodium metabisulfite. In some embodiments, the amount of chain regulator, as a percentage by weight based on the total weight of all monomers used, is 0.5% or more; or 1% or more; or 2% or more; or 4% or more. Independently, in some embodiments, the amount of chain regulator,as a percentage by weight based on the total weight of all monomers used, is 25% or less, such as 18% or less; 12% or less; 8% or less; or even 6% or less. In some embodiments, amounts of initiator larger that the amount needed to initiate polymerization can act as chain regulator.

Other suitable chain regulators include, for example without limitation, OH-containing compounds which are suitable for use in a mixture with water to form a solvent (such as isopropanol and propylene glycol). It is contemplated that, in some embodiments, the chain regulator is a component of the solvent and thus the chain regulator may be present in amounts larger than 25% by weight based on the total weight of all monomers used.

Chain regulator may be added to the reaction vessel in any fashion. In some embodiments, the chain regulator is added to the reaction vessel at a constant rate of addition. In some embodiments, the chain regulator is added to the reaction vessel at a rate of addition that increases or decreases or a combination thereof.

For each ingredient that is added to the reaction vessel, that ingredient may be added in pure form. Alternatively, an ingredient that is added to the reaction vessel may be added in the form of a solution in a solvent, in the form of a mixture with one or more other ingredient, or as a combination thereof (i.e., as a mixture with one or more other ingredient, where that mixture is dissolved in a solvent). The form in which any one ingredient is added to the reaction vessel may be chosen independently of the form in which any other ingredient is added to the reaction vessel.

Additionally, in some embodiments, the polymer having chelating functionality in accordance with the present invention may be produced by aqueous emulsion polymerization techniques. Generally, aqueous emulsion polymerization involves monomer, initiator, and surfactant in the presence of water. The emulsion polymerization may be performed by a method that includes the steps of adding one or more monomers (which may be neat, in solution, in aqueous emulsion, or a combination thereof) to a vessel that contains, optionally with other ingredients, water.

In accordance with the present invention, the one or more monomers used in the emulsion polymerization comprise at least one ethylenically unsaturated aminocarboxylate monomer, as described hereinabove. Additional monomers, selected from ethylenically unsaturated monomers, may also be included.

Initiators suitable for use in emulsion polymerization processes include, for example, water soluble peroxides, such as sodium or ammonium persulfate; oxidants, such as persulfates or hydrogen peroxide, in the presence of reducing agents, such as sodium bisulfite or isoascorbic acid and/or polyvalent metal ions, to form an oxidation/reduction pair to generate free radicals at any of a wide variety of temperatures; water soluble azo initiators, including cationic azo initiators, such as 2,2′-azobis(2-methylpropionamide)dihydrochloride. Furthermore, the emulsion polymerization process may employ one or more oil-soluble initiators, including, for example, oil-soluble azo initiators.

One or more surfactants may be employed. For example, at least one of the surfactants may be selected from alkyl sulfates, alkylaryl sulfates, alkyl or aryl polyoxyethylene nonionic surfactants, and mixtures thereof.

The use, application and benefits of the present invention will be clarified by the following discussion and description of exemplary embodiments of the present invention.

### EXAMPLES

### Example 1

### Synthesis of EDDS-AGE Monomer

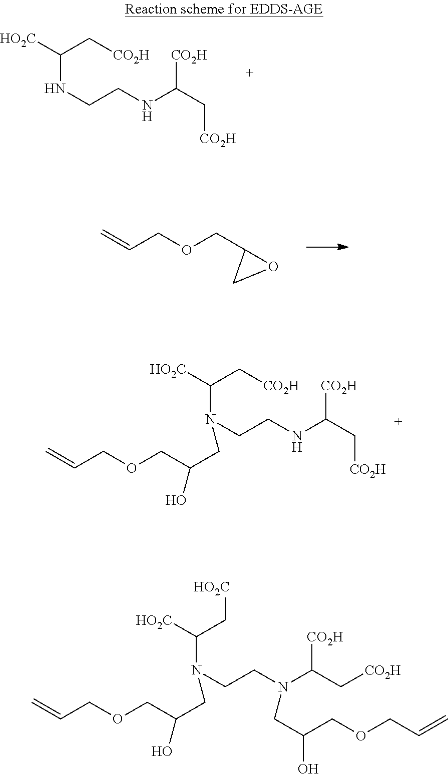

25 mL DI H₂O were added to a 125 mL round bottom flask fixed with overhead stirrer. 42.9 g (0.042 mol) of 35% EDDS (tri-sodium salt) in H₂O were added to the flask. The pH was adjusted to the desired level by adding 95% H₂SO₄ (0 g for 9.4/2 g for 7). The temperature was raised to the desired level (4020 C.-50° C.). 0.25 g of BnMe₃NCl (1.3 mmol) (phase transfer catalyst) were added to the flask. Then, 4.8 g (0.042 mol) AGE were added and the reaction was stirred overnight.

The mass spectrometry results are presented on the following page. To optimize the mono:di-adduct ratio, temperature and pH were adjusted over the ranges stated above. The results are shown in the Table below.

TABLE

| | | | | | overall |
|---|---|---|---|---|---|
| pH | Temperature | yield-mono | yield-di | ratio mono/di | conversion |
| 9.4 | 50° C. | 57.80% | 41.40% | 1.40 | 99% |
| 9.4 | 40° C. | 61.70% | 37.40% | 1.65 | 99% |
| 7 | 40° C. | 58.80% | 39.90% | 1.47 | 99% |
| 7.1 | 50° C. | 63.80% | 34.50% | 1.85 | 98% |
| 7.8 | 45° C. | 75.10% | 23.60% | 3.18 | 99% |
| 7.9 | 45° C. | 69.50% | 29.10% | 2.39 | 99% |

### Example 2

### Synthesis of Poly-(AA/EDDS-AGE)

To a one liter round bottom flask, equipped with a mechanical stirrer, heating mantle, thermocouple, condenser and inlets for the addition of monomer, initiator and chain regulator is charged 100 grams of aqueous solution containing EDDS-AGE (30% actives). Sulfuric acid is added dropwise to the flask to adjust the pH of the solution to 3.5 or below. The solution is set to stir and heated to 78° C. (+/−2° C.). In the meantime, a monomer solution of 45 grams of glacial acrylic acid is added to a graduated cylinder for addition to the flask. An initiator solution of 1.67 grams of sodium persulfate is dissolved in 15 grams of deionized water and added to a syringe for addition to the kettle. A chain regulator solution of 13.39 grams of sodium metabisulfite dissolved in 22.5 grams of deionized water is added to a syringe for addition to the kettle. A promoter solution of 7.75 grams of a 0.15% iron sulfate heptahydrate solution is added to a vial and set aside.

Once the kettle contents reach reaction temperature of 78° C., the promoter solution is added. After the reaction temperature recovered to 78° C., the feeds for the monomer, initiator and CTA solutions are each begun. The monomer feed is added over 90 minutes, CTA cofeed added over 80 minutes and initiator cofeed added over 95 minutes, all at 78° C.

At the completion of the feeds, 5 grams of deionized water is added to the monomer feed vessel, as rinse. The reaction is held for 15 minutes at 78° C. In the meantime, the chaser solutions of 0.29 grams of sodium metabisulfite and 6.6 grams of deionized water is mixed and set aside, and 0.29 grams of sodium persulfate and 5 grams of deionized water is mixed and set aside.

At the completion of the hold, the above solutions are added linearly over 10 minutes and held for 20 minutes at 78° C. The chaser solution preparations are repeated and added to the kettle over 10 minutes, followed by a final 20 minute hold.

At the completion of the final hold, cooling is begun with the addition of 47.50 grams of deionized water. At 50° C. or below, a solution of 46.3 grams of 50% sodium hydroxide is added to an addition funnel and slowly added to the kettle, controlling the exotherm to keep the temperature below 65° C. Finally, 1.4 grams of a scavenger solution of 35% hydrogen peroxide is added to the kettle.

We claim:

1. A polymer having chelating functionality comprising units derived from
(a) an ethylenically unsaturated aminocarboxylate monomer having the following general structure: 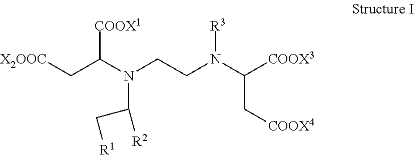
wherein X¹, X², X³ and X⁴ are each, independently, hydrogen or a mono- or polyvalent cation and the total charge on the monomer is zero; one of R¹ and R² is an —OH group, and the other is a polymerizable arm comprising an ethylenically unsaturated group;
and R³ is either: 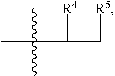
wherein one of R⁴ or R⁵ is an —OH group and the other is a polymerizable arm comprising an ethylenically unsaturated group and derived from one or more ethylenically unsaturated monomers, or 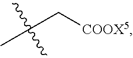
wherein X⁵ is hydrogen or a mono- or polyvalent cation.

2. The ethylenically unsaturated aminocarboxylate monomer according to claim 1, wherein the polymerizable arm of Structure I is derived from a (o-, p-, m-)DVBMO monomer and has the following structure: 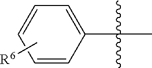
wherein R⁶ is a polymerizable ethylenically unsaturated group located at the ortho-, para-, or meta-substituted position of the benzene ring.

3. The ethylenically unsaturated aminocarboxylate monomer according to claim 2, wherein R⁶ is —CH═CH₂.

4. The ethylenically unsaturated aminocarboxylate monomer according to claim 1, wherein the polymerizable arm of Structure I is derived from an allyl glycidyl ether monomer and has the following structure:

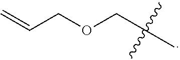 [SMILES: *COCC=C]

5. The ethylenically unsaturated aminocarboxylate monomer according to claim 1, wherein the polymerizable arm of Structure I is derived from a glycidyl(meth)acrylate monomer and has the following structure: 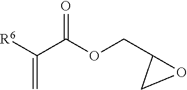
wherein R⁶ is hydrogen or —CH₃.

6. The polymer according to claim 1, wherein the mono- or polyvalent cation may be selected from the group consisting of: Na⁺, K⁺, NH₄⁺, organic ammonium ions, Ca²⁺ and Mg²⁺.

7. The polymer according to claim 1, further comprising units derived from:
(b) one or more ethylenically unsaturated monomers.

8. The polymer according to claim 7, wherein the one or more ethylenically unsaturated monomers are selected from the group consisting of carboxylic acids, esters of carboxylic acids, carboxylic acid anhydrides, imides, amides, styrenes, sulfonic acids, and combinations thereof.

9. The polymer according to claim 7, comprising (a) 0.5-99.5%, by weight, of the ethylenically unsaturated aminocarboxylate monomer, and (b) 99.5-0.5%, by weight, of the one or more ethylenically unsaturated monomers, based on the total weight of the polymer.
